(19) United States
(12) Patent Application Publication
(10) Pub. No.: US 2019/0367640 A1
(43) Pub. Date: Dec. 5, 2019

(54) SOFT-CHEMISTRY PRODUCTION OF NEW NANOSTRUCTURED HYBRID FILMS FROM COLLOIDAL SOLUTIONS OF POLYSACCHARIDE AND SOLUBLE METAL ALKOXIDES

(71) Applicant: UNIVERSITE EUROMEDITERRANEENNE DE FES, Fès (MA)

(72) Inventors: Abdelkrim EL KADIB, Fès (MA); Nisrine HAMMI, Fès (MA); Nadia KATIR, Fès (MA)

(21) Appl. No.: 16/340,732

(22) PCT Filed: Oct. 10, 2017
(86) PCT No.: PCT/MA2017/000021

§ 371 Date: Aug. 7, 2019

(30) Foreign Application Priority Data
Oct. 10, 2016 (MA) 39379

(51) Int. Cl. C08B 37/08; C08J 5/18

(52) U.S. Cl. CPC C08B 37/003; C08J 2305/08; C08J 5/18

(57) ABSTRACT

A method includes producing transparent and mechanically stable hybrid films from a colloidal solution containing one or more biopolymers, one or more soluble metal precursors each including at least two to four hydrolysable alkoxide type functions M(OR)ₙ (n=2, 3 or 4), one or more solvents and optionally a catalyst and a stabiliser.

### FIELD OF THE INVENTION

The present invention describes a new synthesis method, simple and eco-friendly, and which to be specific makes it possible to easily access new hybrid materials in a single step. These new hybrid organic-inorganic bioplastics have the particularity of having organic and inorganic phases intimately bonded at the nanometric scale. These materials come macroscopically as robust and transparent films, thanks in particular to the controlled size of the mineral phase, the homogeneity of the components at the molecular scale, the absence of aggregates of the mineral phase which would make heterogeneous zones appear and also the absence of phase separation. The structural complexity of these materials is illustrated by the possibility of preparing a wide range of hybrids based on polysaccharides enclosing clusters of metal oxides or modified hybrids including, SiO₂₋ₓ(OR)ₓ, TiO₂₋ₓ(OR)ₓ, Fe₂O₂₋ₓ(OR)ₓ, ZrO₂₋ₓ(OR)ₓ, Al₂O₂₋ₓ(OR)ₓ, SnO₂₋ₓ(OR)ₓ, Zn₂₋ₓ(OR)ₓ, GeO₂₋ₓ(OR)ₓ, V₂O₂₋ₓ(OR)ₓ, binary oxides of SiO₂₋ₓ(OR)ₓ—TiO₂₋ₓ(OR)ₓ and SiO₂₋ₓ(OR)ₓ—ZrO₂₋ₓ(OR)ₓ type, ternary oxides of SiO₂₋ₓ(OR)ₓ—TO₂₋ₓ(OR)ₓ—V₂O₂₋ₓ(OR)ₓ type, perovskites of BaTiO₃₋ₓ(OR)ₓ and SrTiO₃₋ₓ(OR)ₓ type, polysiloxanes of PDMS-SiO₂₋ₓ(OR)ₓ, phenyl-bis-siloxane (≡Si—Ar—Si≡) and ethyl-bis-siloxane (≡Si—Et—Si≡) type. This technology is distinguished from those already described by the use of soluble and hydrolysable metal precursors, comprising at least two alkoxide functions of M(OR)₂R′₂ type (M=metal; R′=alkyl, aryl, functional group) and not metal oxides formed beforehand. This in situ polymerisation, operating during the evaporation of the solvent, enables a better control of the size and the morphology of the minerals formed between the fibrils of the polysaccharides and also offers the possibility of accommodating a very high level of the latter in the bioplastic without altering its homogeneity or its transparency.

### PRIOR ART

Hybrid organic-inorganic materials are today giving rise to potential interest in modern technologies thanks to the presence of two complementary phases in the same structure (C. Sanchez et al. Chem. Soc. Rev., 40, 2011, 698-753). This cohabitation gives access to cooperative and synergistic effects, which makes it possible to attain performances greater than those that could be obtained with individual phases. Thus, the mineral part (oxide) provides a better resistance to the system and confers a solid character to the whole of the material, which results in the improvement of its chemical, thermal and mechanical stability. In addition, its porosity is adjustable and it is perfectly possible to create micropores less than 2 nm, mesopores between 2 and 50 nm and macropores of which the pores exceed 50 nm (C. T. Kresge et al., Nature, 359, 1992, 710-712, D. Zhao et al., Science, 279, 1998, 548-552.). This engineering makes it possible to control chemical diffusion in the cavities of these solids and opens the way to their use in varied fields such as selective separation, adsorption, purification and nano-filtration, catalysis, energy and medicine (P. Ciriminna et al., Chem. Rev., 113, 2013, 6592-8820). The organic part, for its part, provides the material with a molecular reactivity that is much more selective than that of a divided inorganic solid (D. Brunei, Micro. Meso. Mater, 27, 1999, 329-344). The hybrid materials obtained in the form of nanostructured films are particularly very sought after, as finished materials (membranes or multilayers) (S. Frindy et al., Carbohydrate Polymer., 146, 2016, 353-361; S, Frindy et al., Carbohydrate Polymer, 167, 2017, 297-305) or instead as potential intermediates for the synthesis of new carbon materials and nanocomposites based on carbon-metal nanoparticle and carbon-metal oxide (S. Frindy et al., ACS Catal., 8, 2016, 3863-3869; A. El Kadib, ChemSusChern, 9, 2016, 238-240).

The synthesis of nanostructured films generally calls on varied immersion techniques: dip-coating, spin-coating, spray and the Langmuir-Blodgett technique, followed by thermal or chemical treatments for the densification of the network and the adhesion of the material formed to the support (C. Sanchez et al., Chem. Mater, 20, 2008,682-737). These synthesis methods necessitate having available suitable infrastructures and devices to ensure a precise design at the nanometric scale. In addition, different substrates are used as growth and adhesion supports, among which may be cited glass slides, silicon substrates, indium tin oxide (ITO) and more flexible organic analogues such as PET (polyethylene terephthalate) and PET-polyimide. One of the most important characteristics during the production of these materials would be the adhesion of the film to the substrate on which the molecular precursor is initially deposited. This adhesion mainly depends on the rheology of the suspension to deposit, its rate of growth and its affinity with the support. Thus, in addition to the necessity of having available sophisticated devices for the experimental preparation of “sol-gel” materials, the feasibility of the experiments itself comes up against a major problem which resides in the incompatibility of the syntheses with the desired implementation and by the constraints imposed by the support. For example, if it is possible to control the formation of the nanostructures in an isotropic and homogenous environment, the control of such structures becomes difficult to achieve with a substrate imposing a direction and thus a preferential orientation. It is also interesting to mention the established limitations in terms of polymerisation kinetics and the anarchic character of the parameters to control, which mainly limits the extension of these syntheses to a wide range of oxides and which require individual optimisations (case by case) and thus an important consumption of time, solvents and energy. The third parameter being the contradiction imposed by the experimental protocol itself: the solution to deposit must adhere strongly to the substrate to ensure the formation of the material and must next have a low adhesion as a material so that it is stripped off and to avoid destroying partially or fully the quality of the final material. As final tricky problem, the major limitation of these techniques resides in the impossibility of controlling the synthesis of binary or ternary compounds having different polymerisation rates. In addition to all the difficulties mentioned above, the problem of phase separation and individual nucleation is added in this precise case.

As alternative to these heterogeneous production protocols involving a liquid phase (sol-gel solution) and a solid substrate, the Inventors have henceforth developed a simple and eco-friendly synthesis method. This method pairs the supramolecular chemistry of polysaccharides with polymerisation by sol-gel method and makes it possible to access, after evaporation of these suspensions, mono-dimensional and isotropic, homogenous and transparent films. This method consists in growing the target metal alkoxides in a colloidal solution containing at least one polysaccharide. The presence of polysaccharide offers the advantage of controlling the size of the sol-gel particles and mastering their growth. The film-forming property of biopolymers used as stabilisers is exploited to obtain films encompassing between their polymer chains oxo-metal oxide clusters. The evaporation of the solvent(s) generates a concentration gradient that makes it possible to densify the inorganic network and thus to access much more compact alternating phases. This technology differs from those described to date for the production of functional films and which use conventional metal oxides as starting materials. Indeed, the first point to resolve when oxides already formed are employed concerns the dispersion of these particles in a solvent; a costly, not very eco-friendly and energy guzzling method. In addition, even with controlled dispersions, the useable quantity remains relatively small and phenomena of sedimentation, precipitation and phase separation from initial mixtures are frequently observed. Also, with an oxide formed beforehand, the synthesis method does not exert any control on the size of the oxide or its aspect. Its interaction with the structuring colloidal solution does not occur at the atomic or molecular level but only interfacial interactions, physically favourable, dominate during dispersion of the oxide with its surrounding medium (polysaccharide-solvent). It is interesting to note that, generally, the Lewis acidity of a solid metal oxide is lower than its soluble molecular precursor. It may be deduced from this fact that the polysaccharide-precursor interaction would be stronger compared to that of a solid polysaccharide-oxide.

In the recent literature, works have concerned the control of the growth of mineral objects (oxides, nanoparticles, clusters, mixed metal oxides, hybrid nanoparticles) in the presence of chitosan, alginate, carrageenan and other biopolymers. However, these disclosed works only relate to the synthesis of finely divided powder and porous microspheres (A. El Kadib and M. Bousmina, ChemEur J., 18, 2012, 8284-8277). No work has concerned the generation of self-structured films from these hybrid colloidal solutions. Hence it was necessary to find a compromise between the supramolecular chemistry governing the interaction with the growing species and, on the other hand, the formation of films, by evaporation of solvent, which induces significant changes in terms of concentration, volume and biopolymer-mineral-solvent interaction.

In addition to its very practical aspect, its ease of implementation and its “eco-design” dimension, one of the potential advantages of this technology concerns the presence of amine (NH₂) functions all along the film (in the case of chitosan) and carboxylic acid (COON) functions in the case of alginates, which confer on these materials an additional reactivity and which is potentially exploitable in promising socio-economic fields such as the fixation and the release of drugs, antibacterial agents and biofertilisers, for detection and bio-detection and for the fixation of

### DESCRIPTION OF THE INVENTION

A first aspect of the invention relates to a new method for preparing hybrid nanostructured films from a colloidal solution containing at least one biopolymer and preferentially a polysaccharide, at least one metal precursor containing between two and four hydrolysable functions of alkoxide M(OR)ₙ type, at least one solvent, and optionally a catalyst and a stabiliser.

According to a second aspect of the invention, the hydrolysis-condensation in said colloidal solution is reported, by sol-gel process at room temperature, of at least one metal precursor containing between two and four alkoxide functions.

According to a third aspect of the invention, it is reported that the colloidal solution of polysaccharide-metal alkoxide is prepared from a polysaccharide, particularly chitosan, chitin, cellulose, starch, alginates, and carrageenan.

A fourth aspect of the invention consists in the use of an aqueous solution of polysaccharide, preferentially acidified (acetic acid-water) in the case of chitosan optionally comprising a co-solvent.

According to a fifth aspect of the invention, the use is reported of alkoxides of silicon, germanium, vanadium, titanium, tin, zinc, zirconium, aluminium, iron, as nucleation precursors during the sol-gel method.

According to a sixth aspect of the invention, the use is reported in the case of silicon, of alkoxides of Si(OR)₄, Si(OR)₃R′, Si(OR)₂R′₂, (OR)₃Si—Ar—Si(OR)₃, CH₃(Si—O—Si)ₙ—CH₂—CH₂—Si(OR)₃ type.

According to a seventh aspect of the invention, it is reported that the metal alkoxide comprises an atrane, acetylacetonate, phosphonate type stabilising function and is solubilised in its parent alcohol to delay polymerisation in the presence of chitosan, to prevent the separation of phases and to ensure the homogeneity of the solution. According to an eighth aspect of the invention, the metal sol-gel method is carried out in a mixture of solvents such as: water, water: methanol, water: ethanol, water: THF, water: isopropanol; at temperatures between 20° and 120° C.

According to a ninth aspect of the invention, the synthesis is reported of films constituted of binary oxides of Si—O—Ti, Si—O—Zr, Si—O—Zn, Si—O—Fe, Si—O—Al, Si—O—Sn, Si—O—Ge, Si—O—V, Ti—O—V, Ti—O—Ge, Ti—O—Sn, Ti—O—Al, Ti—O—Fe, Ti—O—Zn, Ti—O—Zr, V—O—Ge, V—O—Sn, V—O—Al, V—O—Fe, V—O—Zn, V—O—Zr, Fe—O—Zr, Fe—O—Al, Fe—O—Sn, Fe—O—Ge, Zr—O—Al, Zr—O—Sn, Zr—O—Ge, Al—O—Sn, Al—O—Ge, Sn—O—Ge type in a colloidal solution of chitosan.

According to a tenth aspect of the invention, the synthesis is reported of homogenous films comprising ternary compounds of Si—O—Ti—O—Zr, Si—O—Ti—O—V, Si—O—Ge—O—Sn, Si—O—Zn—O—Fe type.

### BRIEF DESCRIPTION OF THE FIGURES

FIG. 1. Illustration of the different existing technologies for the preparation of nanostructured films (a-c) and the technology that is the subject matter of the present invention (d).

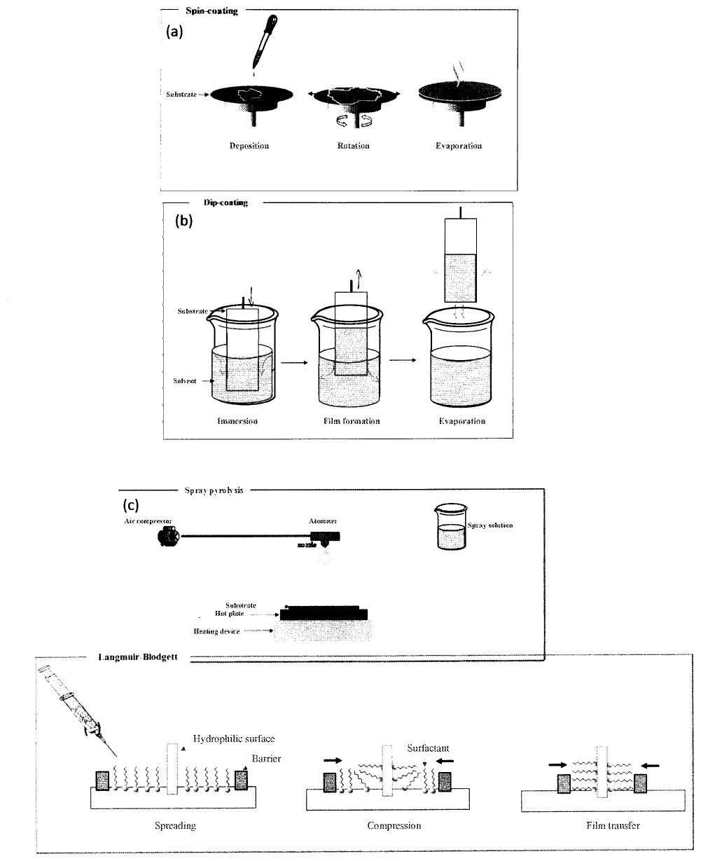

FIG. 2. Diagram showing certain polysaccharides: chitin, chitosan, cellulose, alginates, carrageenan.

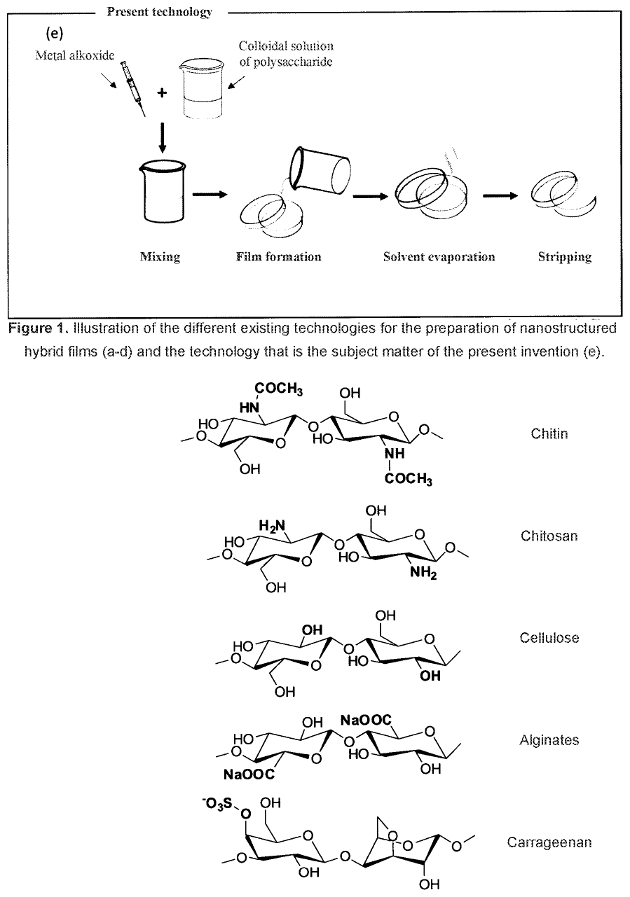

Table 1. Table describing the combinations having made it possible to access nanostructured films of chitosan-metal alkoxide type.

FIG. 3. Diagram showing the alkoxysilanes used.

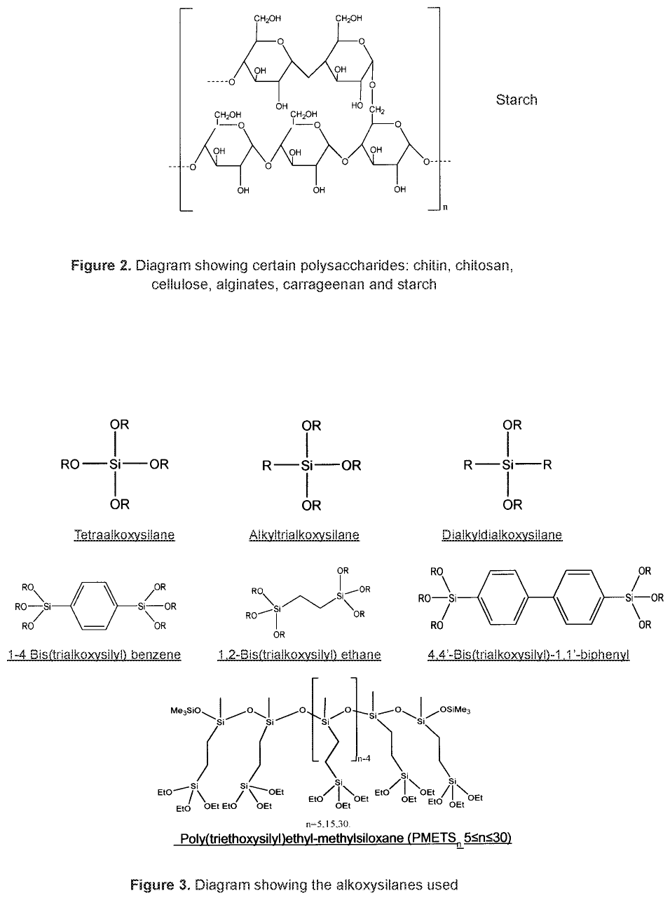

Table 2. Table describing the combinations having made it possible to access nanostructured films of chitosan-alkoxysilane type.

Table 3. Table describing the combinations having made it possible to access nanostructured films of alginate-metal alkoxide type.

FIG. 4. Schematic diagram of the growth by sol-gel process of a metal alkoxide in a colloidal solution of chitosan.

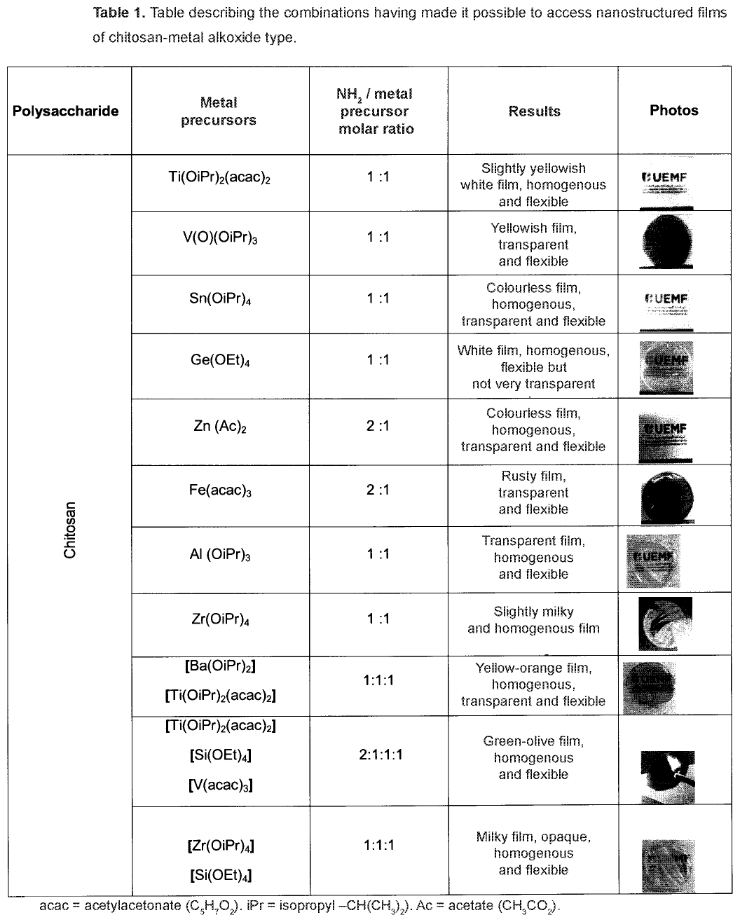

FIG. 5. Schematic diagram of the growth by sol-gel process of a metal alkoxide in a colloidal solution of alginate.

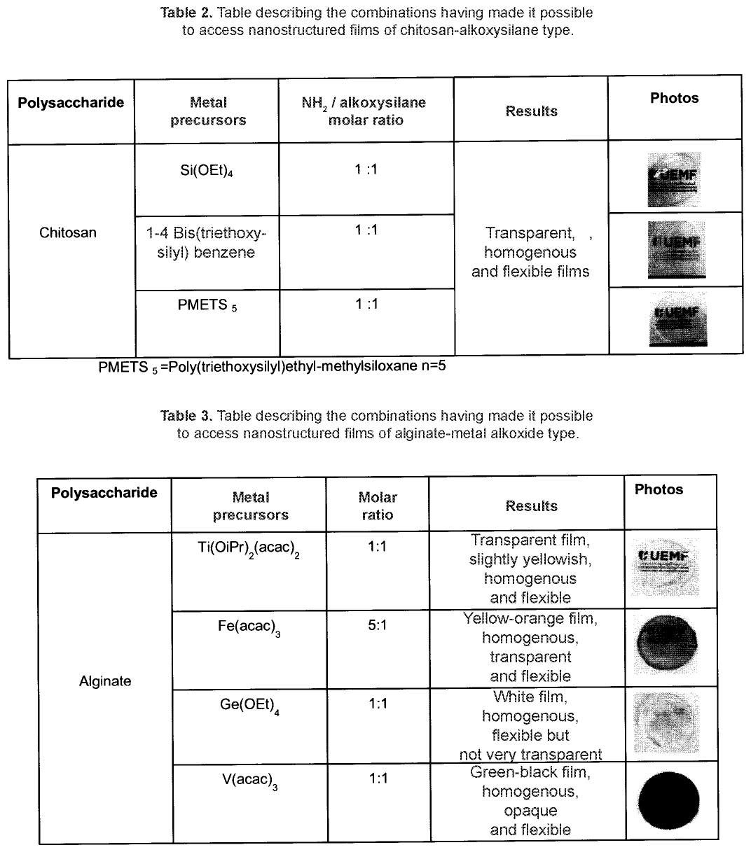

FIG. 6. Scanning electron microscopy and EDX analyses.

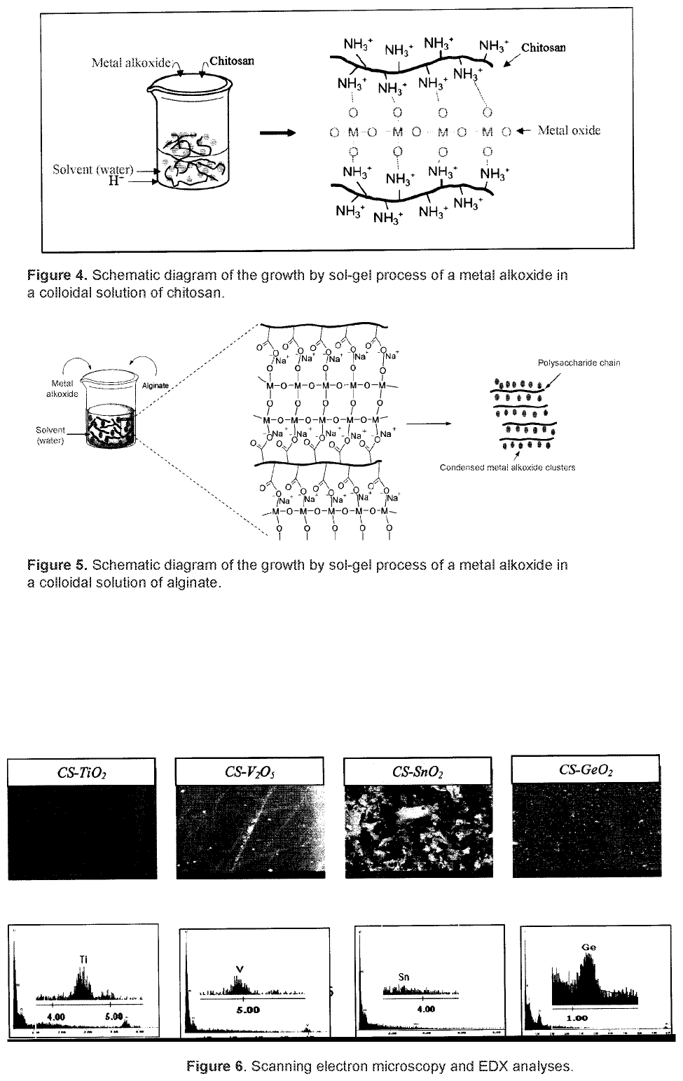

EXAMPLE OF PREPARATION OF NANOSTRUCTURED FILMS

### Chitosan-Oxo-Alkoxy-Titanium Oxide

To an acidified aqueous solution of chitosan (50 mg, 0.29 mmolNH₂) in 4 mL of water—acetic acid 1% (v/v) is added directly drop by drop titanium II diisopropoxy-bis-acetylacetonate (76 mg, 0.21 mmol). The mixture is maintained under stirring for 1 hour at room temperature (25° C.). After, the resulting solution is placed in a petri dish, and exposed to air for 24 hours to enable the evaporation of the solvent. A homogenous film of slightly yellowish white colour and of a mass m=86 mg was able to be obtained.

### Chitosan-Silica

To an acidified aqueous solution of chitosan (50 mg, 0.29 mmolNH₂) in 4 mL of water—acetic acid 1% (v/v) is added directly tetraethoxysilane (60 mg, 0.29 mmol). The mixture is maintained under stirring for 1 hour at room temperature (25° C.). Next, the solution obtained is placed in a petri dish, and exposed to air for 24 hours to enable the evaporation of the solvent. A colourless film, transparent and homogenous, of a mass m=56 mg was able to be obtained.

### Chitosan-Oxo-Alkoxy-Vanadium Oxide

To an acidified aqueous solution of chitosan (100 mg, 0.58 mmolNH₂) in 4 mL of water—acetic acid 1% (v/v) is added oxytriisopropoxy vanadium (V) (103 mg, 0.42 mmol). The mixture is maintained under stirring for 4 days at room temperature (25° C.). After, the resulting solution is placed in a petri dish, and exposed to air for 24 hours to enable the evaporation of the solvent. A homogenous film of yellow colour and of a mass m=98 mg was able to be obtained.

### Chitosan-Oxo-Alkoxy-Tin Oxide

To an acidified aqueous solution of chitosan (50 mg, 0.29 mmolNH₂) in 4 mL of water—acetic acid 1% (v/v) is added tetraisopropoxy tin (IV) (103 mg, 0.29 mmol). The mixture is maintained under stirring for 1 hour at room temperature (25° C.). After, the resulting solution is placed in a petri dish, and exposed to air for 24 hours to enable the evaporation of the solvent. A colourless film, transparent and homogenous, and of a mass m=54 mg was able to be obtained.

### Chitosan-Oxo-Alkoxy-Germanium Oxide

To an acidified aqueous solution of chitosan (100 mg, 0.58 mmolNH₂) in 4 mL of water—acetic acid 1% (v/v) is added tetraethoxy germanium (IV) (147 mg, 0.58 mmol). The mixture is maintained under stirring for 1 hour at room temperature (25° C.). After, the resulting solution is placed in a petri dish, and exposed to air for 24 hours to enable the evaporation of the solvent. A homogenous film of white colour and of a mass m=153 mg was able to be obtained.

### Chitosan-Oxo-Alkoxy-Zinc Oxide

To an acidified aqueous solution of chitosan (50 mg, 0.29 mmolNH₂) in 4 mL of water—acetic acid 1% (v/v) is added zinc acetate (25 mg, 0.145 mmol). The mixture is maintained under stirring for 1 hour at room temperature (25° C.). After, the resulting solution is placed in a petri dish, and exposed to air for 24 hours to enable the evaporation of the solvent. A colourless film, transparent, and of a mass m=68 mg was able to be obtained.

### Chitosan-Oxo-Alkoxy-Iron Oxide

To an acidified aqueous solution of chitosan (50 mg, 0.29 mmolNH₂) in 4 mL of water—acetic acid 1% (v/v) is added a solution of iron (III) acetylacetonate (50 mg, 0.145 mmol) in 5 mL of water—acetic acid 1% (v/v). The mixture is maintained under stirring for 1 hour at room temperature (25° C.). After, the resulting solution is placed in a petri dish, and exposed to air for 24 hours to enable the evaporation of the solvent. A homogenous film of rusty colour and of a mass m=82 mg was able to be obtained.

### Chitosan-Oxo-Alkoxy-Aluminium Oxide

To an acidified aqueous solution of chitosan (50 mg, 0.29 mmolNH₂) in 4 mL of water—acetic acid 1% (v/v) is added aluminium triisopropoxide (60 mg, 0.29 mmol). The mixture is maintained under stirring for 1.5 h at room temperature (25° C.). After, the resulting solution is placed in a petri dish, and exposed to air for 24 hours to enable the evaporation of the solvent. A colourless film, transparent and homogenous, and of a mass m=56.5 mg was able to be obtained.

### Chitosan-Oxo-Alkoxy-Zirconium Oxide

To an acidified aqueous solution of chitosan (50 mg, 0.29 mmolNH₂) in 4 mL of water—acetic acid 1% (v/v) is added a solution of zirconium tetrabutoxide (137 mg, 0.29 mmol) in 1 mL of ethanol. The mixture is maintained under stirring for 5 hours at room temperature (25° C.). After, the resulting solution is placed in a petri dish, and exposed to air for 24 hours to enable the evaporation of the solvent. A slightly milky film and of a mass m=103 mg was able to be obtained.

### Chitosan-Oxo-Alkoxy-Titanium Oxide-Oxo-Alkoxy-Silicon Oxide

To a mixture of titanium bis (acetylacetonate) diisopropoxide (106 mg, 0.29 mmol) and TEOS (60 mg, 0.29 mmol) in 1 mL of ethanol is added an acidified aqueous solution of chitosan (50 mg, 0.29 mmolNH₂) in 4 mL of water—acetic acid 1% (v/v). The mixture is maintained under stirring for 1 hour at room temperature (25° C.). After, the resulting solution is placed in a petri dish, and exposed to air for 24 hours to enable the evaporation of the solvent. A homogenous film of slightly orangey colour and of a mass m=92.7 mg was able to be obtained.

### Chitosan-Oxo-Alkoxy-Zirconium Oxide-Oxo-Alkoxy-Silicon Oxide

To a mixture of zirconium tetrabutoxide (137 mg, 0.29 mmol) and TEOS (60 mg, 0.29 mmol) in 1 mL of ethanol is added an acidified aqueous solution of chitosan (50 mg, 0.29 mmolNH₂) in 4 mL of water—acetic acid 1% (v/v).The mixture is maintained under stirring for 1.5 h at room temperature (25° C.). After, the resulting solution is placed in a petri dish, and exposed to air for 24 hours to enable the evaporation of the solvent. A homogenous film of milky colour and of a mass m=97.9 mg was able to be obtained.

### Chitosan-Oxo-Alkoxy-Titanium Oxide-Oxo-Alkoxy-Silicon Oxide-Oxo-Alkoxy-Vanadium Oxide

To a mixture of vanadium (III) acetylacetonate (50 mg, 0.145 mmol), titanium diisopropoxy-bis-(acetylacetonate) (53 mg, 0.145 mmol) and TEOS (30 mg, 0.145 mmol) in 1 mL of ethanol is added an acidified aqueous solution of chitosan (50 mg, 0.29 mmolNH₂) in 4 mL of water—acetic acid 1% (v/v). The mixture is maintained under stirring for 2 hours at room temperature (25° C.). After, the resulting solution is placed in a petri dish, and exposed to air for 24 hours to enable the evaporation of the solvent. A homogenous film of green-olive colour and of a mass m=116 mg was able to be obtained.

### Chitosan-BaTiO₃

To a mixture of barium isopropoxide (74 mg, 0.29 mmol) and titanium diisopropoxy-bis-acetylacetonate (106 mg, 0.29 mmol) in 1 mL of ethanol is added an acidified aqueous solution of chitosan (50 mg, 0.29 mmolNH₂) in 4 mL of water—acetic acid 1% (v/v). The mixture is maintained under stirring for 1 hour at room temperature (25° C.). After, the resulting solution is placed in a petri dish, and exposed to air for 24 hours to enable the evaporation of the solvent. A homogenous film of orange yellow colour and of a mass m=107 mg was able to be obtained.

1. A method comprising producing transparent and mechanically stable hybrid films from a colloidal solution containing one or more biopolymers, one or more soluble metal precursors each comprising at least two to four hydrolysable alkoxide type functions M(OR). (n=2, 3 or 4), one or more solvents and optionally a catalyst and a stabiliser.

2. The method according to claim 1, wherein the colloidal solution is prepared using a coordinating species that is a bio-polymer of chitosan, chitin, cellulose, alginate, carrageenan, starch type, or a mixture of two or more components, perfectly soluble in the solvent(s) used of which one is necessarily water.

3. The method according to claim 2, wherein a growing species for producing the hybrid film is the one or more soluble metal precursor soluble in its parent alcohol and comprising between two and four alkoxide functions M(OR)ₙ (n=2, 3 or 4), of which the central metal is of Si, Ti, Zr, Zn, Fe, Al, Ge, Sn, V type, a mixture of two precursors or a mixture of several precursors.

4. The method according to claim 3, wherein the silicon alkoxide used comprises between 1 hydrolysable silicon atom (in the case of tetraethoxysilane) up to 30 hydrolysable silicon atoms, in the case of polymethylethyltriethoxysilylsiloxane.

5. The method according to claim 4, wherein a spacer between two silicon atoms is a flexible unit of methyl, ethyl, propyl, pentyl, hexyl, heptyl, decyl nature or rigid of aryl, biphenyl, pyrene, naphthyl type.

6. The method according to claim 3, wherein the growing species in the solution of bio-polymer contains at least one single chelating function of atrane, acetylacetonate, carboxylic acid, phosphonate type to delay polymerisation.

7. The method according to claim 3, wherein the growing species is a mixture of metal alkoxides M(OR)₄ without organic groups (with M═Si, Ti, Zr, Zn, Fe, Al, Ge, Sn, V) and a second bis- or tris-organoalkoxysilane of (R′O)₃Si—R—Si(OR′)₃ type of which the spacer is of methyl, ethyl, propyl, pentyl, hexyl, heptyl, decyl nature or rigid of aryl, biphenyl, pyrene, naphthyl type.

8. The method according to claim 3, wherein the growing species is a mixture of metal alkoxides M(OR)₄ without organic groups (with M═Si, Ti, Zr, Zn, Fe, Al, Ge, Sn, V) and a source of hydrolysable silicon of polymethylethyltriethoxysilylsiloxane type of which the chain length varies between 5 and 30.

9. The method according to claim 2, wherein the growing species generates a perovskite of BaTiO₃₋ₓ(OR)ₓ, SrTiO₃₋ₓ(OR)ₓ, PDMS-SiO₂₋ₓ(OR′)ₓBaTiO_{3-y}(OR)_{y} and PDMS-SiO₂₋ₓ(OR′)ₓSrTiO_{3-y}(OR)_{y} type.

10. The method according to claim 1, comprising performing a densification of the oxo-alkoxy-metal oxide-polysaccharide network between 25 and 100° C., in a mixture of solvents.

11. The method according to claim 10, wherein the mixture of solvents include water: ethanol, water: isopropanol, water: butanol, water: THF, water: toluene, water: heptane, water: acetonitrile, water: DMSO; or lwater: DMF
